(19) United States
(12) Patent Application Publication
(10) Pub. No.: US 2004/0134877 A1
(43) Pub. Date: Jul. 15, 2004

(54) magnetoresistance apparatus having reduced overlapping of permanent magnet layer and method for manufacturing the same

(75) Inventors: Nobuyuki Ishiwata, Tokyo (JP); Shigeru Mori, Tokyo (JP); Kiyokazu Nagahara, Tokyo (JP); Tsutomu Ishi, Tokyo (JP); Kunihiko Ishihara, Tokyo (JP); Eizo Fukami, Tokyo (JP); Masafumi Nakada, Tokyo (JP)

Correspondence Address: YOUNG & THOMPSON, 745 SOUTH 23RD STREET 2ND FLOOR, ARLINGTON, VA, 22202

(73) Assignee: TDK CORPORATION, TOKYO (JP)

(21) Appl. No.: 10/750,946

(22) Filed: Jan. 5, 2004

Related U.S. Application Data
(62) Division of application No. 09/466,810, filed on Dec. 20, 1999, now abandoned.

(30) Foreign Application Priority Data
Dec. 18, 1998 (JP) 10-360159

(51) Int. Cl. B44C 1/22

(52) U.S. Cl. 216/22

(57) ABSTRACT

In a magnetoresistance apparatus including a first functional layer and a second functional layer magnetically connected to the first functional layer, an overlapping ratio of the second functional layer onto the first functional layer is approximately 0 to 10 percent.

### BACKGROUND OF THE INVENTION

1. Field of the Invention

The present invention relates to a magnetoresistance (MR) apparatus such as a spin valve type transducer and a tunneling magnetoresistance (TMR) transducer and a method for manufacturing the MR apparatus.

2. Description of the Related Art

As magnetic storage apparatuses have been developed in size and capacity, highly sensitive magnetoresitive (MR) sensors (heads) have been put into practical use (see: Robert P. Hunt, “A Magnetoresistive Readout Transducer”, IEEE Trans. on Magnetics, Vol. MAG-7, No. 1, pp.150-154, March 1971). Since use is made of the anisotropy magnetoresistance effect of NiFe alloy, these MR heads are called AMR heads.

Recently, more highly sensitive giant magnetoresistance (GMR) sensors (heads) have also been developed in order to achieve higher area recording density (see: Ching Tsang et al., “Design, Fabrication & Testing of Spin-Valve Read Heads for High Density Recording”, IEEE Trans. on Magnetics, Vol. 30, No. 6, pp. 3801-3806, November 1994). A typical GMR head is constructed by a free ferromagnetic layer, a pinned ferromagnetic layer and a non-magnetic conductive layer sandwiched by the free ferromagnetic layer and the pinned ferromagnetic layer. In the GMR head, the resultant response is given by a cosine of an angle between the magnetization directions of the free ferromagnetic layer and the pinned ferromagnetic layer.

In the spin valve type transducer, bias ferromagnetic layers, i.e., permanent magnet layers are provided at the sides of the spin valve structure to provide magnetic domain control over the free ferromagnetic layer, thus suppressing the Barkhausen noise.

In a prior art method for manufacturing a spin valve type transducer (see: JP-A-3-125311), after a doubled-photoresist pattern is formed on a spin valve type structure, the spin valve type structure is etched by an ion beam etching process, using the doubled-photoresist pattern as a mask, and then, a permanent magnet layer is deposited by a magnetron sputtering process using the doubled-photoresist pattern. This will be explained later in detail.

In the above-described prior art method, however, the overlapping ratio of the permanent magnet layer onto the spin valve type structure is large. As a result, an area having a magnetic field opposite to the magnetic field of the permanent magnetic layer is generated in the free layer, so that boundaries of magnetic domains are generated in the free layer. The boundaries are irregularly moved by an external magnetic field within the free layer, which increases the Barkhausen noise. In particular, if the track width is very small, the effect of the boundaries is very harmful.

The above-mentioned problem in the spin valve type transducer occurs in a TMR transducer which is constructed by a pinned ferromagnetic layer, a free ferromagnetic layer, a non-magnetic insulating layer sandwiched by the pinned ferromagnetic layer and the free ferromagnetic layer, and permanent magnet layers provided at the sides of the free ferromagnetic layer.

Note that a technology using an ion beam sputtering process is known as forming a spin valve structure (see: Hari Hedge et al., “Fabricating spin valves by ion-beam deposition”, DATA STORAGE, pp.69-70, September 1998); however, there is no discussion on the above-mentioned overlapping problem.

### SUMMARY OF THE INVENTION

It is an object of the present invention to provide an MR apparatus capable of reducing the Barkhausen noise and a method for manufacturing such an MR apparatus.

According to the present invention, in an MR apparatus including a first functional layer and a second functional layer magnetically connected to the first functional layer, an overlapping ratio of the second functional layer onto the first functional layer is approximately 0 to 10 percent.

Also, in a method for manufacturing an MR apparatus, after a doubled-photoresist pattern is formed on a magnetoresistance element layer, the magnetoresistance element layer is etched by an ion beam etching process using the doubled-photoresist pattern as a mask, and then, a permanent magnet layer is deposited by an ion beam sputtering process using the doubled-photoresist pattern.

### BRIEF DESCRIPTION OF THE DRAWINGS

The present invention will be more clearly understood from the description set forth below, as compared with the prior art, with reference to the accompanying drawings, wherein:

FIGS. 1A through 1F are cross-sectional, air bearing surface (ABS) views for explaining a prior art method for manufacturing a spin valve type transducer;

FIG. 2 is a cross-sectional view of an enlargement of the boundary portion between the spin valve structure and the permanent magnet layer of FIG. 1F;

FIG. 3 is a graph showing the magnetoresistance-external magnetic field of the transducer of FIG. 1F;

FIGS. 4 and 5 are plan views for explaining magnetic domains of the free layer and the permanent magnet layer of FIG. 2;

FIGS. 6A through 6F are cross-sectional, ABS views for explaining a first embodiment of the method for manufacturing an MR transducer according to the present invention;

FIG. 7 is a cross-sectional view of an enlargement of the boundary portion between the spin valve structure and the permanent magnet layer of FIG. 6F;

FIG. 8 is a graph showing the magnetoresistance-external magnetic field of the transducer of FIG. 6F;

FIGS. 9 and 10 are plan views for explaining magnetic domains of the free layer and the permanent magnet layer of FIG. 7;

FIG. 11A is a cross-sectional view for explaining the overlapping ratio of the present invention;

FIG. 11B is a graph showing the magnetoresistance-external magnetic field of the transducer of FIG. 11A;

FIG. 12 is a graph showing the relationship between the overlapping ratio and the hysteresis characteristics of the transducer of FIG. 6F;

FIGS. 13A through 13F are cross-sectional, ABS views for explaining a second embodiment of the method for manufacturing an MR transducer according to the present invention; and

FIG. 14 is a block circuit diagram illustrating a magnetic storage apparatus to which the MR transducer according to the present invention is applied.

### DESCRIPTION OF THE PREFERRED EMBODIMENTS

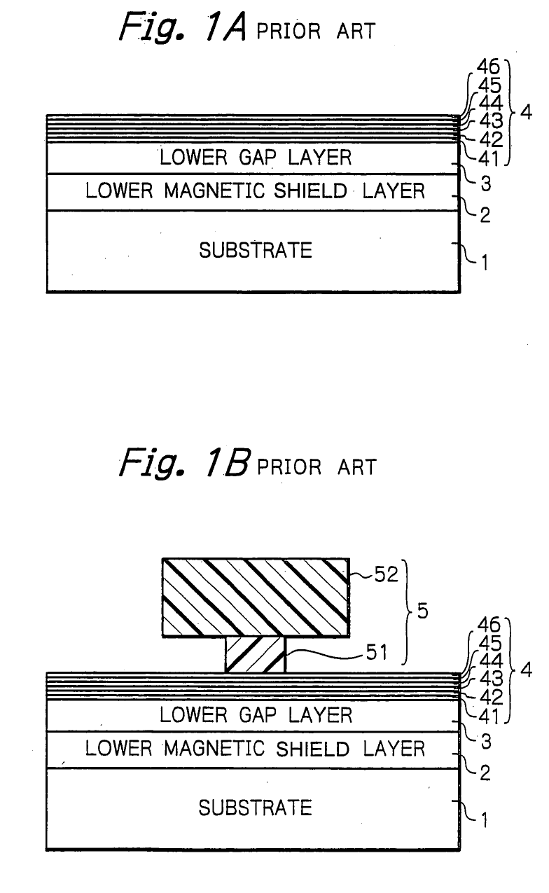

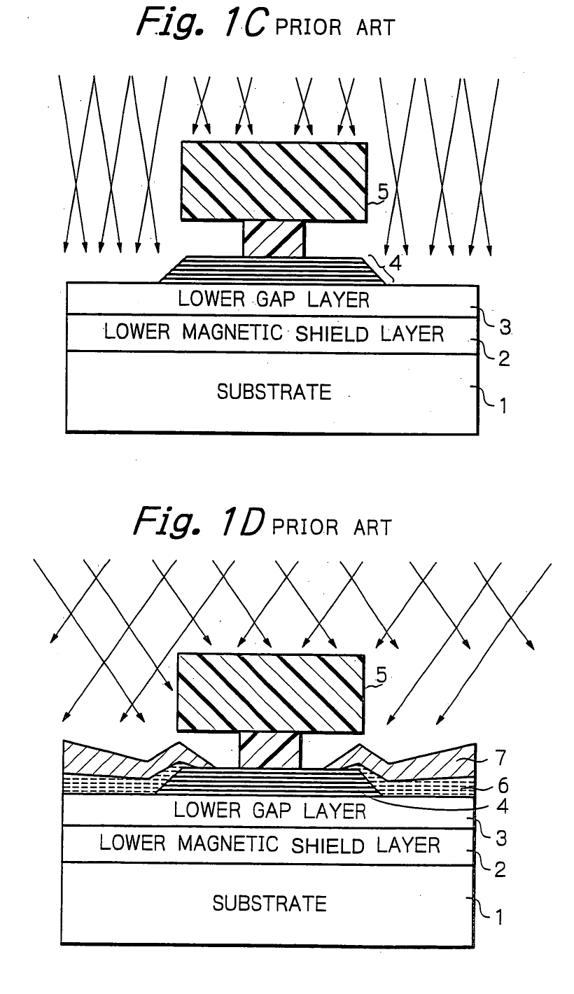

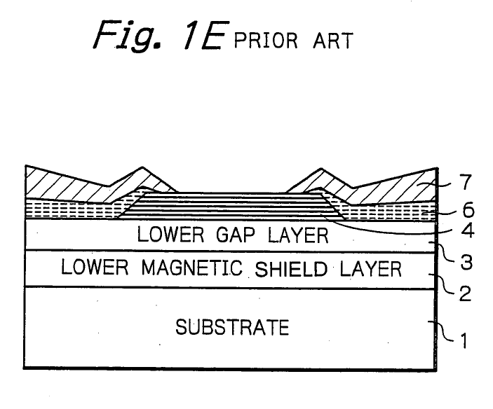

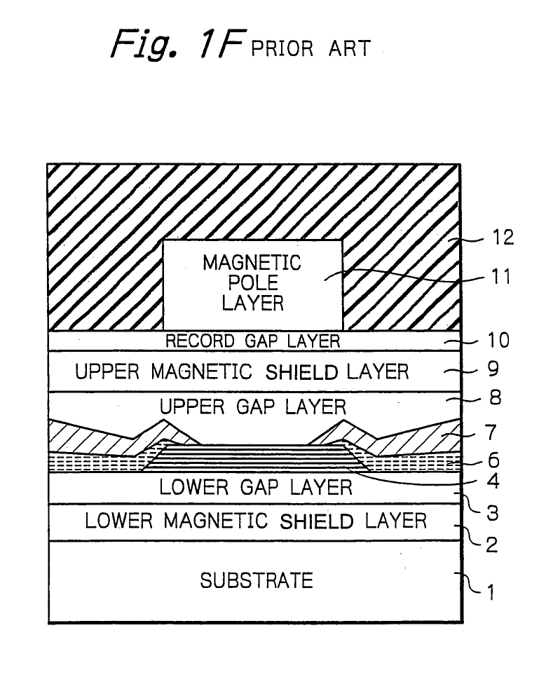

Before the description of the preferred embodiments, a prior art method for manufacturing a spin valve type transducer will be explained with reference to FIGS. 1A through 1F, 2, 3, 4 and 5.

First, referring to FIG. 1A, an about 1 μm thick lower magnetic shield layer 2 made of CoTaZrCr is deposited on a substrate 1 made of Al₂O₃.TiC which serves as a slider. Then, an about 80 nm thick lower gap layer 3 made of alumina is deposited on the lower magnetic shield layer 2.

Next, a spin valve structure 4 is deposited on the lower gap layer 3, by a magnetron sputtering process, a radio frequency sputtering process or an ion beam sputtering process. That is, an about 3 nm thickunder layer 41 made of Zr, an about 25 nm thick pinning layer 42 made of antiferromagnetic material such as PtMn, an about 3 nm thick pinned layer 43 made of ferromagnetic material such as CoFe, an about 2.7 nm thick non-magnetic conductive layer 44 made of Cu, a free layer 45 made of ferromagnetic material such as about 1 nm thick CoFe and about 6 nm thick NiFe, and an about 3 nm thick protection layer 46 made of Zr are sequentially deposited on the lower gap layer 3.

Next, referring to FIG. 1B, a photoresist pattern 5 formed by an upper photoresist pattern 51 and a lower photoresist pattern 52 is formed on the spin valve structure 4. In this case, the area of the lower photoresist pattern 51 is smaller than that of the upper photoresist pattern 52. The height of the lower photoresist pattern 51 is about 0.2 μm in view of the flat characteristics. Note that a double configuration of the photoresist pattern 5 can be easily made by using two kinds of photoresist materials having different etching rates for one etching process.

Next, referring to FIG. 1C, the spin valve structure 4 is patterned by an ion beam etching process using the photoresist pattern 5 as a mask. As a result, the patterned spin value structure 4 is a mesa-shape due to the small ion beam scattering phenomenon.

Next, referring to FIG. 1D, an about 30 nm thick permanent magnet layer 6 made of CoPt and an about 50 nm thick electrode layer 7 made of Au are sequentially deposited by a magnetron sputtering process using an Ar gas pressure of about 0.67 Pa (5 mTorr). In this case, the permanent magnet layer 6 and the electrode layer 7 overlap the spin valve structure 4 due to the large magnetron scattering phenomenon.

Note that an about 10 nm thick underlayer (not shown) made of Cr can be formed under the permanent magnet layer 6 so as to increase the coercive force of the permanent magnet layer 6.

Next, referring to FIG. 1E, the photoresist pattern 5 is lifted off.

Finally, referring to FIG. 1F, an about 60 nm thick upper gap layer 8 made of Al₂O₃ (alumina), an about 2 μm thick upper magnetic shield layer 9 made of NiFe, an about 0.15 μm record gap layer 10 made of alumina, and an about 2 μm thick magnetic pole layer 11 made of CoFeNi are sequentially deposited. Then, an Al₂O₃ (alumina) layer 12 is coated. Note that an exciting winding (not shown) isolated by the photoresist layer (not shown) is formed between the upper magnetic shield layer 9 and the magnetic pole layer 11.

Thus, the spin valve type transducer is completed.

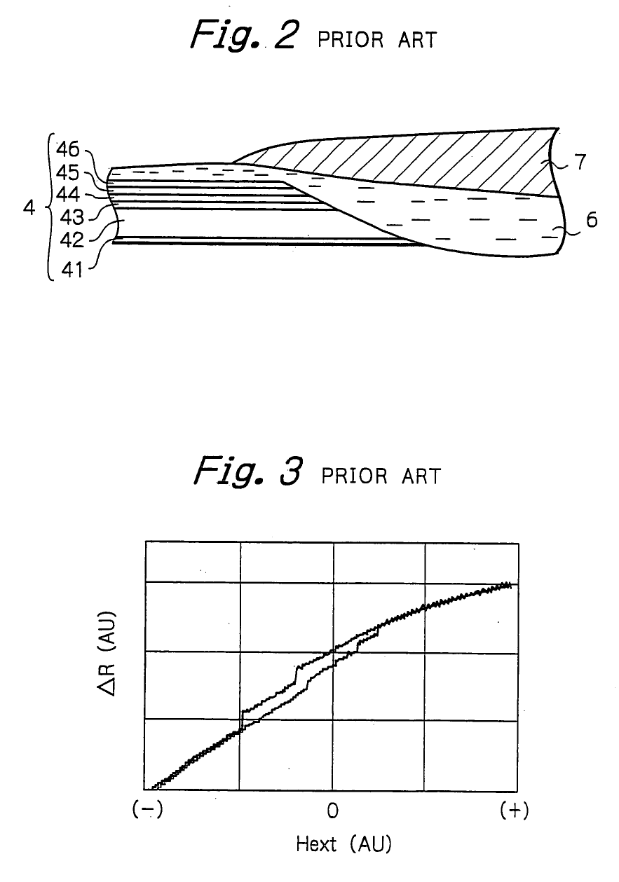

As illustrated in FIG. 2, which is an enlargement of the boundary portion between the spin valve structure 4 and the permanent magnet layer 6 (the electrode layer 7) of FIG. 1F, a large part of the permanent magnet layer 6 overlaps the spin valve structure 4. Therefore, the permanent magnet layer 6 incompletely biases the free layer 45 of the spin valve structure 4, so that the direction of magnetization of the free layer 45 incompletely coincides with that of the permanent magnet layer 6, which insufficiently suppresses the Barkhausen noise. This will be explained layer. Also, as shown in FIG. 3, the magnetic domain of the free layer 45 cannot sufficiently be controlled by the magnetic field of the permanent magnet layer 6, so that a large hysteresis is created in a magnetoresistance and magnetic field (R-H) loop, which also increases the noise in regenerated signals.

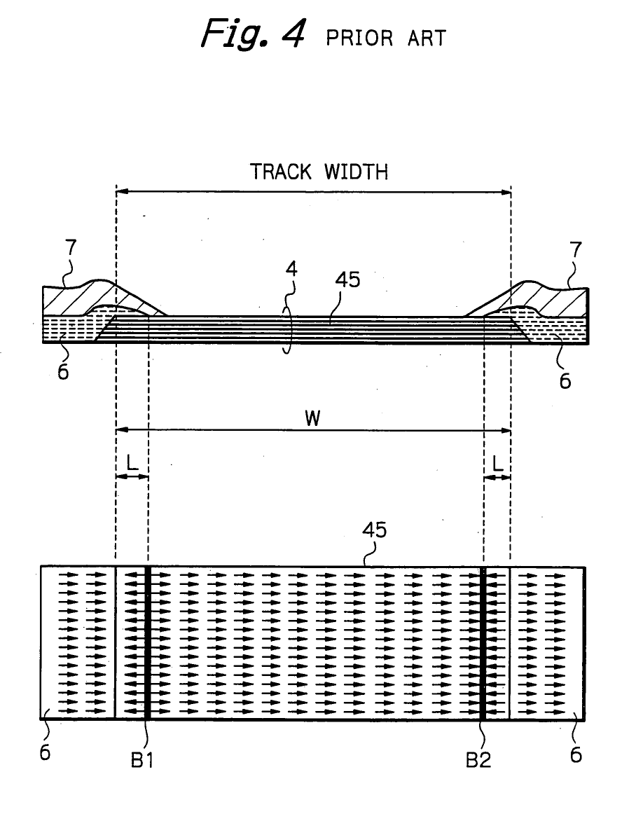

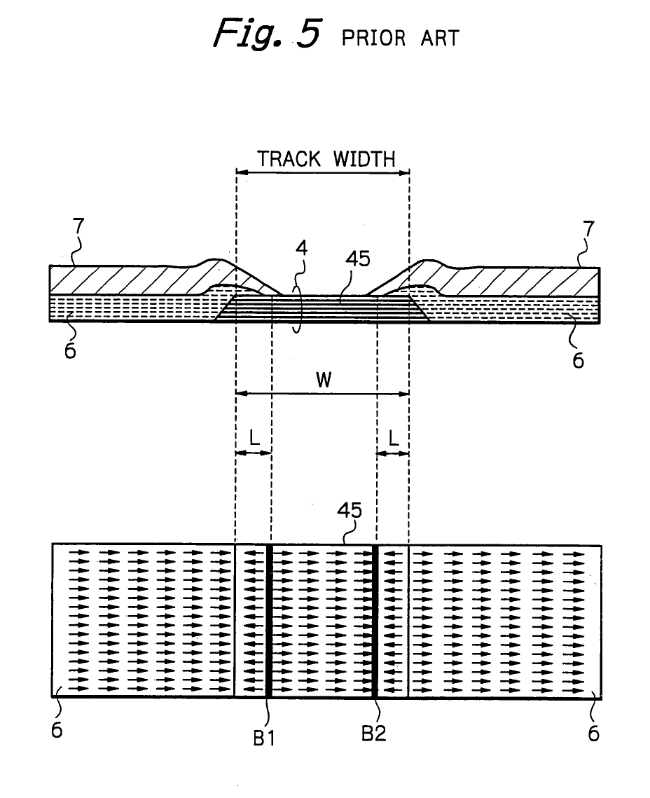

The bias operation of the permanent magnet layer 6 upon the free layer 45 of FIG. 2 is explained with reference to FIGS. 4 and 5.

As illustrated in FIG. 4, in principle, the direction of magnetization of the free layer 45 coincides with the permanent magnet layer 6. However, if the permanent magnet layer 6 overlaps the free layer 45, an area having a magnetic field opposite to the magnetic field of the permanent magnetic layer 6 is generated in the free layer 45, so that boundaries B1 and B2 of magnetic domains are generated in the free layer 45. The boundaries B1 and B2 are irregularly moved within the free layer 45 by an external magnetic field Hₑₓₜ, which increases the noise.

Note that if the track width W is relatively large so that the ratio of the overlapping amount L to the track width W is relative small, the effect of the boundaries B1 and B2 can be negligible; however, as illustrated in FIG. 5, if the track width W is relatively small, for example, less than 1 μm so that the above-mentioned ratio is relatively large, the effect of the boundaries B1 and B2 cannot be neglegible.

Also, since plasma gas is present on the surface of the wafer in the magnetron sputtering process as illustrated in FIG. 1D, the photoresist layer 5 is heated, so that the photoresist layer 5 is deformed, decreasing the manufacturing yield.

Thus, in the above-described prior art method, since sputtering particles emitted from a target have a large dispersion angle as illustrated in FIG. 1D and also the mean free path of sputtering particles is very short due to the high pressure of inert gas such as Ar gas, the scattering effect of sputtering particles is remarkable, so that the permanent magnet layer 6 and the electrode layer 7 greatly overlap the spin valve structure 4.

In order to reduce the scattering effect of sputtering particles, it is suggested that the height of the lower photoresist layer 51 be low so as to suppress the invasion of sputtering particles under the upper photoresist layer 52. For example, if the track width W is less 1 μm, it is suggested that the height of the lower photoresist layer 51 be less than 0.05 μm. However, it is actually difficult to coat the lower photoresist layer 51 having such a thickness in view of the homogeneity of thickness of the lower photoresist layer 51 over the entire wafer, which would decrease the manufacturing yield.

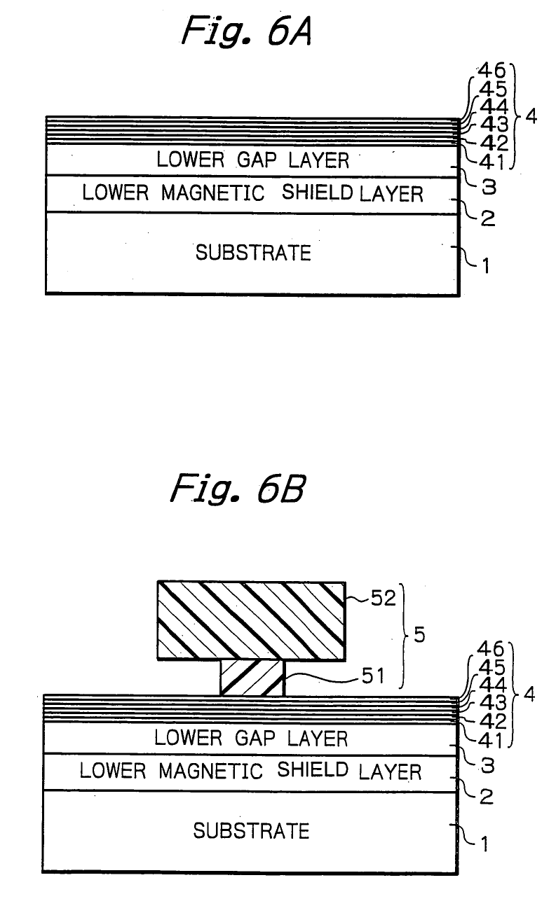

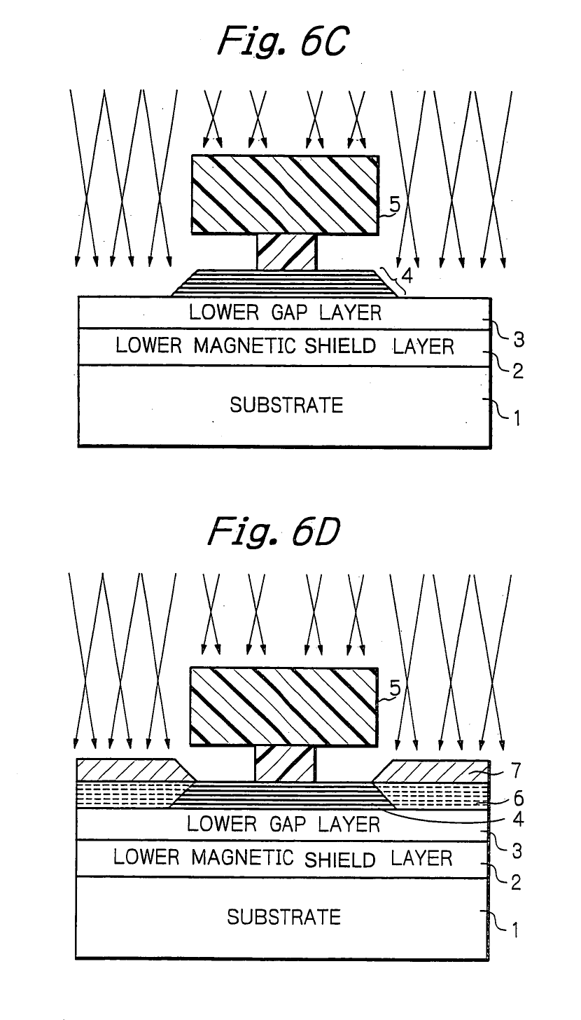

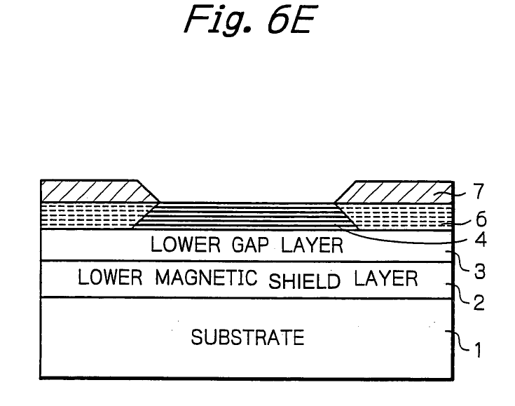

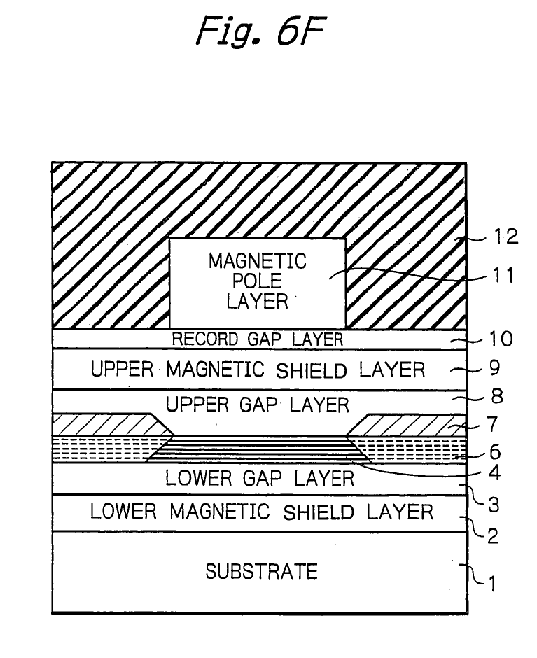

A first embodiment method for manufacturing an MR transducer according to the present invention will be explained next with reference to FIGS. 6A through 6F. In the first embodiment, the transducer is of a spin valve type.

First, referring to FIG. 6A, in the same way as in FIG. 1A, an about 1 μm thick lower magnetic shield layer 2 made of CoTaZrCr is deposited on a substrate 1 made of Al₂O₃.TiC which serves as a slider. Then, an about 80 nm thick lower gap layer 3 made of alumina is deposited on the lower magnetic shield layer 2.

Next, a spin valve structure 4 is deposited on the lower gap layer 3 is by a magnetron sputtering process, a radio frequency sputtering process or an ion beam sputtering process. That is, an about 3 nm thick underlayer 41 made of Zr, an about 25 nm thick pinning layer 42 made of antiferromagnetic material such as PtMn, an about 3 nm thick pinned layer 43 made of ferromagnetic material such as CoFe, an about 2.7 nm thick non-magnetic conductive layer 44 made of Cu, a free layer 45 made of ferromagnetic material such as about 1 nm thick CoFe and about 6 nm thick NiFe, and an about 3 nm thick protection layer 46 made of Zr are sequentially deposited on the lower gap layer 3.

Next, referring to FIG. 6B, in the same way as in FIG. 1B, a photoresist pattern 5 formed by an upper photoresist pattern 51 and a lower photoresist pattern 52 is formed on the spin valve structure 4. In this case, the area of the lower photoresist pattern 51 is smaller than that of the upper photoresist pattern 52. The height of the lower photoresist pattern 51 is about 0.05 to 0.3 μm, preferably, 0.2 μm in view of the flat characteristics.

Next, referring to FIG. 6C, in the same way as in FIG. 1C, the spin valve structure 4 is patterned by an ion beam etching process using the photoresist pattern 5 as a mask. As a result, the patterned spin valve structure 4 is a mesa-shape due to the small ion beam scattering phenomenon.

Next, referring to FIG. 6D, an about 30 nm thick permanent magnet layer 6 made of CoPt and an about 50 nm thick electrode layer 7 made of Au are sequentially deposited by an ion beam sputtering process using an Ar gas pressure of about 4×10⁻⁴ to 4×10⁻² Pa (3×10⁻⁶ to 3×10⁻⁴ Torr), preferably, 1.33×10⁻³ Pa (1×10⁻⁵ Torr) where the distance between the center of targets and a wafer rotating at 10 rpm is about 20 to 100 cm, preferably, 25 cm. Note that the minimum value 4×10⁻⁴ Pa of Ar gas pressure is defined in view of the stabilization of an ion source, and the maximum value 4×10⁻² Pa of Ar gas pressure is defined in view of the scattering effect of particles. Also, the minimum value 20 cm of the above-mentioned distance is defined in view of the scattering effect of particles, and the maximum value 100 cm of the above-mentioned distance is defined in view of the growth speed of the permanent magnet layer 6 and the electrode layer 7. In this case, the permanent magnet layer 6 and the electrode layer 7 do not overlap the spin value structure 4 due to the small ion beam scattering phenomenon. If any, the overlapping amount of the permanent magnet layer 6 and the electrode layer 7 onto the spin value structure 4 is very small.

Also, since no plasma gas is present on the surface of the wafer in the ion beam sputtering process as illustrated in FIG. 6D, the photoresist layer 5 is hardly heated, so that the photoresist layer 5 is not deformed, increasing the manufacturing yield.

Further, when growing the electrode layer 7 made of Au, it is suggested Xe gas instead of Ar gas be used in view of the resistance value of the electrode layer 7. The resistivity of the electrode layer 7 made of Au was 9 μΩcm in the case of Ar gas, while the resistivity of the electrode layer 7 made of Au was 3 μΩcm in the case of Xe gas. Note that the electrode layer 7 has the same configuration regardless of whether Ar gas or Xe gas is used.

The ion beam etching process as illustrated in FIG. 6C and the ion beam sputtering process as illustrated in FIG. 6D are carried out in the same ion beam chamber without exposing the wafer to air. Therefore, the interface between the spin valve structure 4 and the permanent magnet layer 6 can be prevented from being contaminated, thus improving the magnetoresistance (MR) ratio.

Note that an about 10 nm thick underlayer (not shown) made of Cr can be formed under the permanent magnet layer 6 so as to increase the coercive force of the permanent magnet layer 6.

Next, referring to FIG. 6E, in the same way as in FIG. 1E, the photoresist pattern 5 is lifted off.

Finally, referring to FIG. 6F, in the same way as in FIG. 1F, an about 60 nm thick upper gap layer 8 made of Al₂O₃ (alumina), an about 2 μm thick upper magnetic shield layer 9 made of NiFe, an about 0.15 μm record gap layer 10 made of alumina, an about 2 μm thick magnetic pole layer 11 made of CoFeNi are sequentially deposited. Then, an Al₂O₃ layer 12 is coated. Note that an exciting winding (not shown) isolated by a photoresist layer (not shown) is formed between the upper magnetic shield layer 9 and the magnetic pole layer 11.

Thus, the spin valve type transducer is completed.

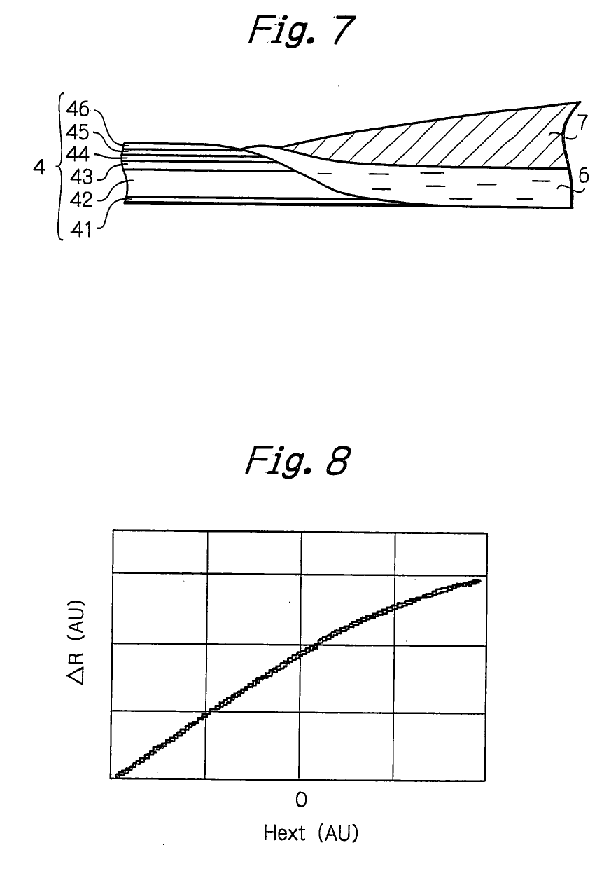

As illustrated in FIG. 7, which is an enlargement of the boundary portion between the spin valve structure 4 and the permanent magnet layer 6 (the electrode layer 7) of FIG. 6F, the permanent magnet layer 6 does not overlap the spin valve structure 4, or a small part of the permanent magnet layer 6 overlaps the spin valve structure 4, if any. Therefore, the permanent magnet layer 6 completely biases the free layer 45 of the spin valve structure 4, so that the direction of magnetization of the free layer 45 completely coincides with that of the permanent magnet layer 6, which sufficiently suppresses the Barkhausen noise. This will be explained later. Also, as shown in FIG. 8, the magnetic domain of the free layer 45 can be sufficiently controlled by the magnetic field of the permanent magnet layer 6, so that no hysteresis is created in a magnetoresistance and magnetic field (R-H) loop, which also decreases the noise in regenerated signals.

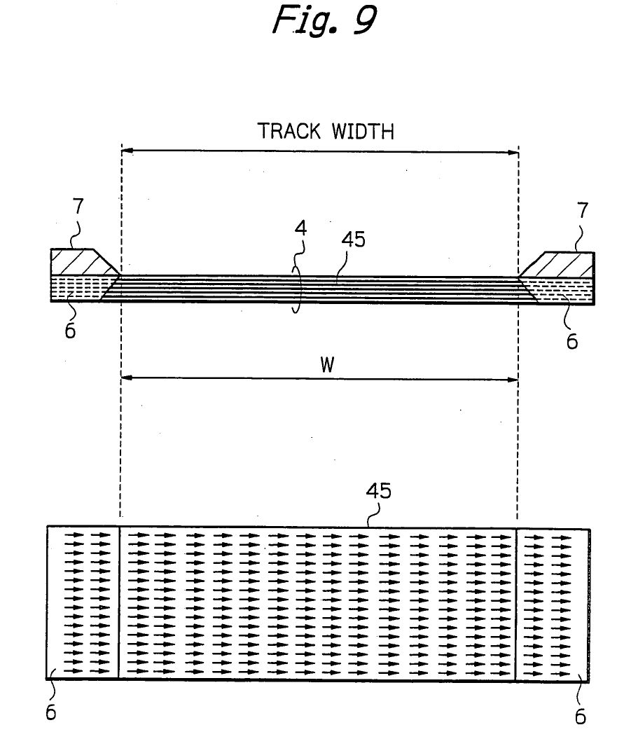

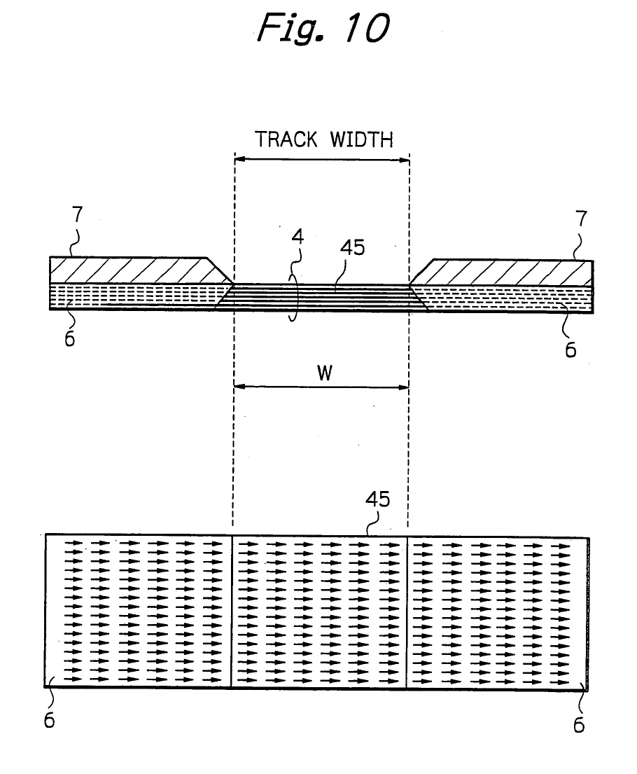

The bias operation of the permanent magnet layer 6 upon the free layer 45 of FIG. 7 is explained next with reference to FIGS. 9 and 10.

As illustrated in FIG. 9, in principle, the direction of magnetization of the free layer 45 coincides with the permanent magnet layer 6. In this case, if the permanent magnet layer 6 does not overlap the free layer 45, an area having a magnetic field opposite to the magnetic field of the permanent magnetic layer 6 is not generated, so that no boundary of magnetic domains is generated in the free layer 45. Therefore, the magnetic field within the free layer 45 is regularly moved by an external magnetic field Hₑₓₜ, which suppresses the noise.

Also, as illustrated in FIG. 10, even if the track width W is relatively small, for example, less than 1 μm, no boundary of magnetic domains is generated, which also suppresses the noise.

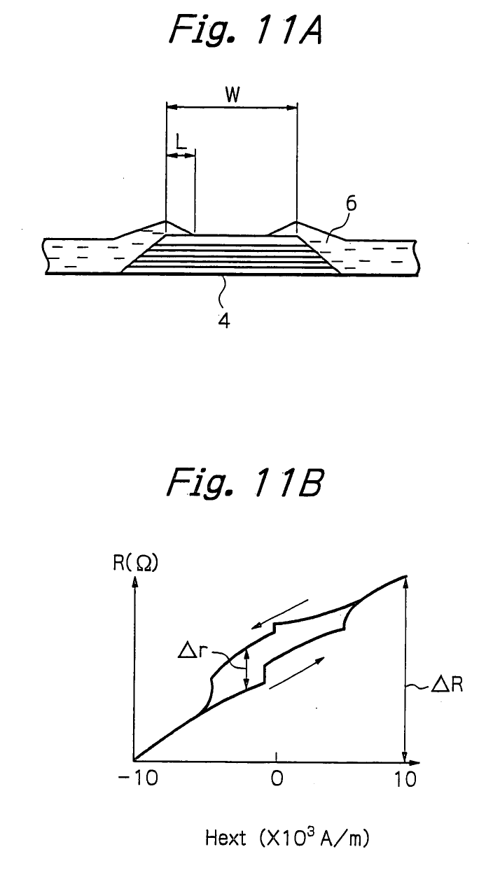

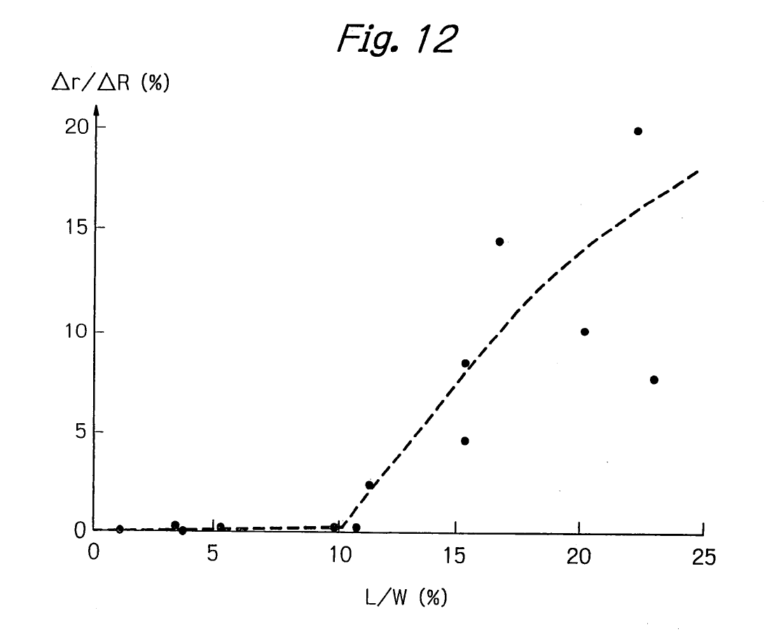

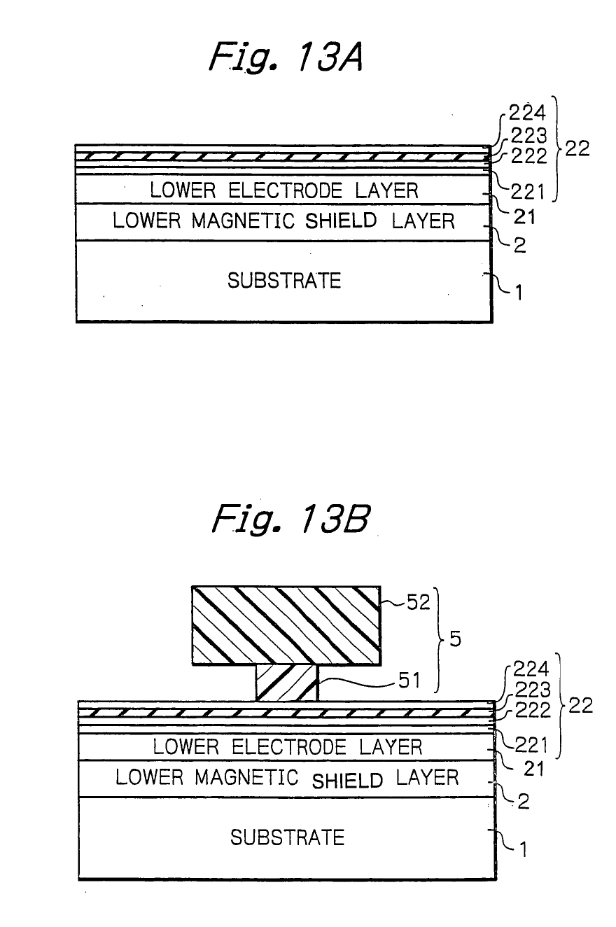

As explained above, in the above-described first embodiment, only a small part of the permanent magnet layer 6 overlaps the spin valve structure 4; however, the inventors found that if the overlapping ratio L/W is smaller than 0.1, the noise is not substantially increased. That is, if the track width W and the overlapping amount L of the permanent magnet layer 6 are defined as shown in FIG. 11A and the hysteresis amount is defined by Δr/ΔR in a magnetoresistance and magnetic field loop as shown in FIG. 11B, it was found that Δr/ΔR was almost zero when the overlapping ratio L/W was less than about 10 percent, as shown in FIG. 12.

Thus, if the overlapping ratio L/W is smaller than about 10 percent, the noise can be sufficiently suppressed.

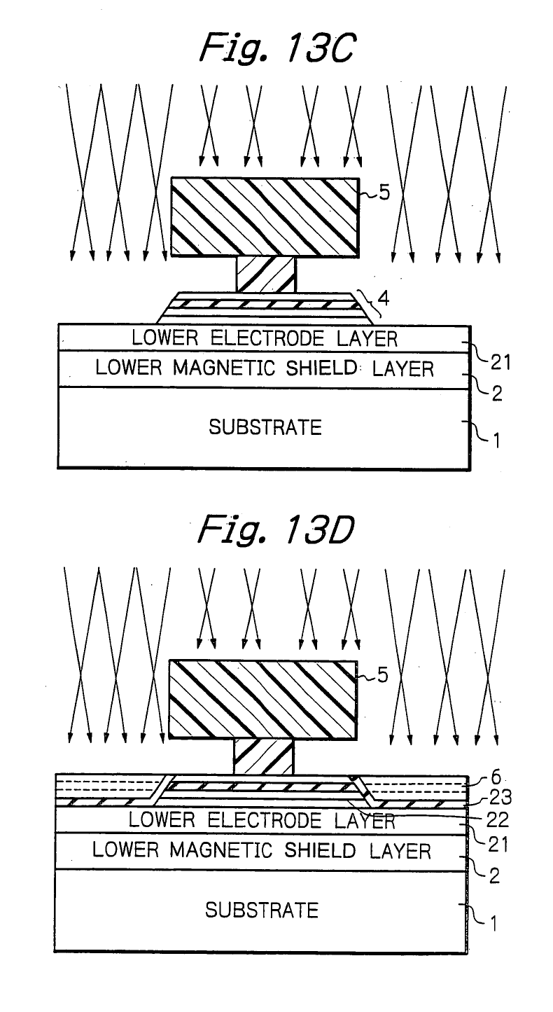

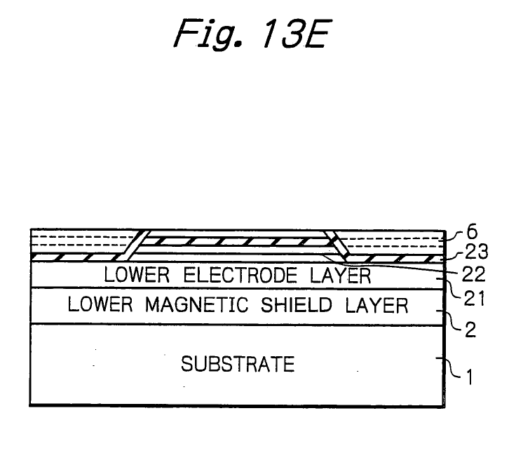

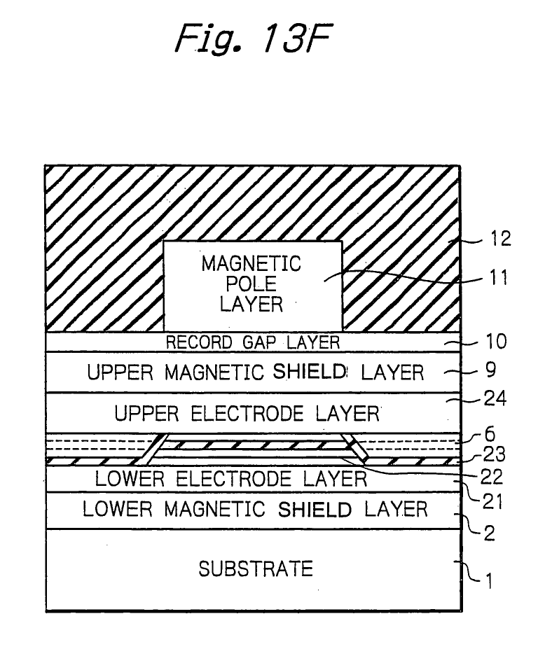

A second embodiment method for manufacturing an MR transducer according to the present invention will be explained next with reference to FIGS. 13A through 13F. In the second embodiment, the transducer is of a TMR type.

First, referring to FIG. 13A, an about 1 μm thick lower magnetic shield layer 2 made of CoTaZrCr is deposited on a substrate 1 made of Al₂O₃.TiC which serves as a slider. Then, an about 80 nm thick lower electrode layer 21 made of Ta or Au is deposited on the lower magnetic shield layer 2.

Next, a TMR structure 22 is deposited on the lower electrode layer 21 by a magnetron sputtering process, a radio frequency sputtering process or an ion beam sputtering process. That is, an about 25 nm thick pinning layer 221 made of antiferromagnetic material such as PtMn, an about 3 nm thick pinned layer 222 made of ferromagnetic material such as CoFe, an about 1.0 nm thick non-magnetic insulating layer 223 made of Al₂O₃ or the like and a free layer 224 made of ferromagnetic material such as about 5 nm thick NiFe are sequentially deposited on the lower electrode layer 21.

Next, referring to FIG. 13B, in the same way as in FIG. 1B, a photoresist pattern 5 formed by a lower photoresist pattern 51 and an upper photoresist pattern 52 is formed on the TMR structure 22. In this case, the area of the lower photoresist pattern 51 is smaller than that of the upper photoresist pattern 52. The height of the lower photoresist pattern 51 is about 0.05 to 0.3 μm, preferably, 0.2 μm in view of the flat characteristics.

Next, referring to FIG. 13C, the TMR structure 22 is patterned by an ion beam etching process using the photoresist pattern 5 as a mask. As a result, the patterned TMR structure 22 is a mesa-shape due to the small ion beam scattering phenomenon.

Next, referring to FIG. 13D, an about 20 nm thick insulating layer 23 made of alumina and an about 30 nm thick permanent magnet layer 6 made of CoPt are sequentially deposited by anion beams puttering process using an Ar gas pressure of about 4×10⁻⁴ to 4×10⁻² Pa (3×10⁻⁶ to 3×10⁻⁴ Torr), preferably, 1.33×10⁻³ Pa (1×10⁻⁵ Torr) where the distance between the center of targets and a wafer rotating at 10 rpm is about 20 to 100 cm, preferably, 25 cm. Note that the minimum value 4×10⁻⁴ Pa of Ar gas pressure is defined in view of the stabilization of an ion source, and the maximum value 4×10⁻² Pa of Ar gas pressure is defined in view of the scattering effect of particles. Also, the minimum value 20 cm of the above-mentioned distance is defined in view of the scattering effect of particles, and the maximum value 100 cm of the above-mentioned distance is defined in view of the growth speed of the insulating layer 23 and the permanent magnet layer 6. In this case, the insulating layer 23 and the permanent magnet layer 6 do not overlap the TMR structure 22 due to the small ion beam scattering phenomenon. If any, the overlapping amount of the insulating layer 23 and the permanent magnet layer 6 onto the TMR structure 22 is very small.

Also, since no plasma gas is present on the surface of the wafer in the ion beam sputtering process as illustrated in FIG. 13D, the photoresist layer 5 is hardly heated, so that the photoresist layer 5 is not deformed, increasing the manufacturing yield.

The ion beam etching process as illustrated in FIG. 13C and the ion beam sputtering process as illustrated in FIG. 13D are carried out in the same ion beam chamber without exposing the wafer to air. Therefore, the interface between the TMR structure 22 and the permanent magnet layer 6 can be prevented from being contaminated, thus improving the magnetoresistance (MR) ratio.

Note that an about 10 nm thick underlayer (not shown) made of Cr can be formed under the permanent magnet layer 6 so as to increase the coercive force of the permanent magnet layer 6.

Next, referring to FIG. 13E, in the same way as in FIG. 1E, the photoresist pattern 5 is lifted off.

Finally, referring to FIG. 13F, an about 80 nm thick upper electrode layer 24 made of Ta or Au, an about 2 μm thick upper magnetic shield layer 9 made of NiFe, an about 0.15 μm record gap layer 10 made of Alumina, and an about 2 μm thick magnetic pole layer 11 made of CoFeNi are sequentially deposited. Then, a Al₂O₃ layer 12 is coated. Note that an exciting winding (not shown) isolated by the photoresist layer (not shown) is formed between upper magnetic shield layer 9 and the magnetic pole layer 11.

Thus, the TMR type transducer is completed.

In the second embodiment as illustrated in FIGS. 13A through 13F, the same effect can be expected as in the first embodiment as illustrated in FIGS. 6A through 6F.

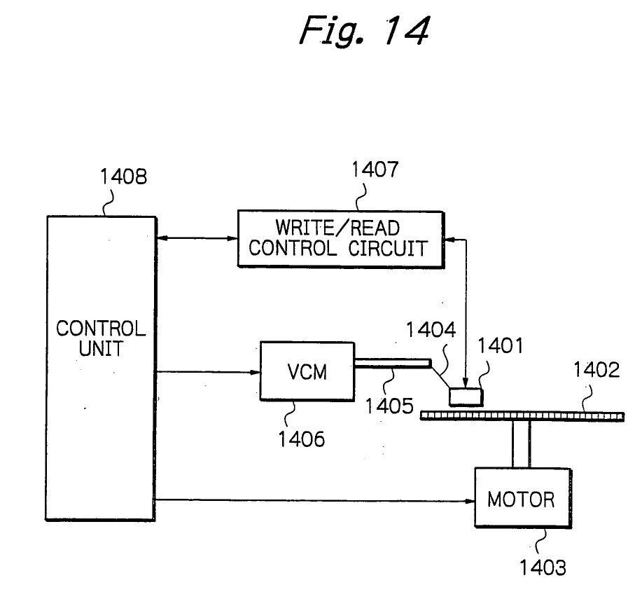

The MR transducer of FIG. 6F (13F) is applied to a magnetic storage apparatus as illustrated in FIG. 14. In FIG. 14, a magnetic write/read head 1401 including the MR transducer of FIG. 6F (13F) faces a magnetic medium 1402 rotated by a motor 1403. The magnetic write/read head 1401 is coupled via a suspension 1402 to an arm 1403 driven by a voice coil motor 1406. Thus, the magnetic write/read head 1401 is tracked by the voice coil motor 1406 to the magnetic medium 1402. The magnetic write/read head 1402 is controlled by a write/read control circuit 1407. Also, the motor 1403, the voice coil motor 1406 and the write/read control circuit 1407 are controlled by a control unit 1408.

As explained hereinabove, according to the present invention, since the overlapping amount of the permanent magnet layer onto the spin value structure or the TMR structure is decreased, the noise can be suppressed.

What is claimed:

1. A method for manufacturing a magnetoresistance apparatus, comprising the steps of:
forming a magnetoresistance element layer;
forming a photoresist pattern on said magnetoresistance element layer;
etching said magnetoresistance element layer by using said photoresist pattern as a mask; and
depositing a side layer by an ion beam sputtering process using said photoresist pattern as a mask after said magnetoresistance element layer is etched.

2. The method as set forth in claim 1, wherein said photoresist pattern has a lower photoresist pattern and an upper photoresist pattern formed on said lower photoresist pattern, said lower photoresist pattern having a smaller area than said upper photoresist pattern.

3. The method as set forth in claim 2, wherein said lower photoresist pattern is approximately 0.05 to 0.3 μm.

4. The method as set forth in claim 1, wherein a gas pressure in said ion beam sputtering process is about 4×10⁻⁴ to 4×10⁻² Pa.

5. The method as set forth in claim 1, wherein ion beams used in said ion beam sputtering process are Ar ion beams.

6. The method as set forth in claim 1, wherein ion beams used in said ion beam sputtering process are Xe ion beams.

7. The method as set forth in claim 1, wherein a distance between a target and a substrate for said side layer in said ion beam sputtering process is approximately 20 to 100 cm.

8. The method as set forth in claim 1, wherein said magnetoresistance element layer etching step carries out an ion beam etching process.

9. The method as set forth in claim 1, wherein said magnetoresistance element layer etching step and said side depositing step are carried out in one chamber without exposing said magnetoresistance apparatus to air.

10. The method as set forth in claim 1, wherein said magnetoresistance element layer comprises a spin valve type structure,
said side layer comprising a permanent magnet layer and an electrode layer formed on said permanent magnet layer.

11. The method as set forth in claim 1, wherein said magnetoresistance element layer comprises a tunneling magnetoresistance type structure,
said side layer comprising an insulating layer and a permanent magnet layer formed on said insulating layer,
said method further comprising a step of forming an electrode layer on said tunneling magnetoresistance structure.
